(19) United States
(12) Patent Application Publication
(10) Pub. No.: US 2004/0010989 A1
(43) Pub. Date: Jan. 22, 2004

(54) Adhesive-backed extender trim material

(76) Inventor: Ken R. Rivest, Tallahassee, FL (US)

Correspondence Address: John Wiley Horton, Attorney, Pennington, Moore, Wilkinson,, Bell & Dunbar, P.A., P.O. Box 10095, Tallahassee, FL, 32302-2095, US

(21) Appl. No.: 10/198,216

(22) Filed: Jul. 18, 2002

(51) Int. Cl. E06B 1/04

(52) U.S. Cl. 52/204.5; 52/204.1

(57) ABSTRACT

A deformable plastic trim strip useful for trimming the installation of doors, windows, and the like. The trim strip has a first side suitable for viewing in a finished installation, and a second side with an attached band of contact adhesive. In storage, the contact adhesive is covered by a peelable backing. The trim strip is formed of material which is capable of some deformation while retaining the elastic memory to retain its original flat shape. The trim strip can be cut, bent, roll formed, etc. to produce the shape desired for the installation. The user then removes the peelable backing and uses the contact adhesive to affix the strip in the desired location. The trim strip is preferably stored in a roll within a dispenser box. The dispenser box allows the compact storage and transportation of many feet of the material.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of construction and repair. More specifically, the invention comprises a trim material useful for completing the installation of windows, doors, and the like.

2. Description of the Related Art

FIG. 1 shows a typical window installed in the wall of a structure. Those skilled in the art will know that there are many variations in window and wall construction known in the art. Thus, the illustrations in FIGS. 1 through 6 are merely representative. Old window 10 is installed in wall 11. Panels of siding 12 cover the exterior of wall 11. Window casings 14—typically wood boards—are attached both to old window 10 and to siding 12. They provide a finished appearance, as well as providing a moisture seal. The exterior surface of wall 11 could also typically be covered by lapped board siding, brick veneer, or vinyl.

FIG. 2 shows the same structure from the interior side of wall 11. There would typically be insulation, drywall, and other materials present in this view. These have been removed in order to clearly illustrate the structure. Wall 11 is formed by a series of studs 16. When wall 11 is framed, provisions must be made for the mounting of old window 10. A series of cripple studs 22 are installed. An opening for the window is then formed through the use of header 18, two portal sides 24, and a portal base 20. Again, there are many different approaches to forming such a portal. The one illustrated is merely representative.

Old window 10 is installed within the portal thus formed. A series of shims 26 are used to bridge the gap between portal sides 24 and old window 10. These also serve to center the window in the opening.

It is common for windows to be replaced long before the structure containing them wears out. FIG. 3 illustrates the first step in the process of removing a window. Casings 14 have been removed, exposing opening 28 in siding 12. FIG. 4 shows old window 10 having been removed from wall 11. Shims 26 are shown still attached to old window 10, though in reality they may be removed during the process. The reader will observe that header 18, the two portal sides 24, and portal base 20 are now visible through opening 28. A new window must typically be attached using these elements.

FIG. 5 shows new window 30 in position for installation. As for old window 10, there are many different types of new window 30. The replacement window shown is formed of vinyl. It consists primarily of box structure 34. The mounting methodology for new window 30 is different, as it is designed to be attached using long screws driven through the side jambs and into the surrounding window opening.

Those skilled in the art will know that many older windows were made to non-standard sizes. Although many sizes of new windows are now available, it is often only possible to approximate the size of a window to be replaced. This is the case for the version shown in FIG. 5. FIG. 6 shows new window 30 installed in opening 28. Window facing 32 is the forward-facing portion of the window. It provides the basis for attaching any trim elements.

The reader will observe that the new window is an inexact fit. Gaps 38 are visible around the perimeter. These will need to be properly covered, both for aesthetic and functional purposes. In addition, window facing 32 does not provide a truly finished appearance. Although it can be painted, it is often not intended to present the same visual appeal as the casings 14 did for old window 10. Accordingly, a new element is needed. This new element comprises the present invention.

### BRIEF SUMMARY OF THE INVENTION

The present invention comprises a plastic trim strip useful for trimming the installation of doors, windows, and the like. The trim strip has a first side suitable for viewing in a finished installation, and a second side with an attached band of contact adhesive. In storage, the contact adhesive is covered by a peelable backing. The trim strip is formed of material which is capable of some deformation while retaining the elastic memory to retain its original flat shape. The trim strip can be cut, sheared, mitered, sanded, etc. to produce the shape desired for the installation. The user then removes the peelable backing and uses the contact adhesive to affix the strip in the desired location. The trim strip is preferably stored in a roll within a dispenser box. The dispenser box allows the compact storage and transportation of many feet of the material.

### BRIEF DESCRIPTION OF THE SEVERAL VIEWS OF THE DRAWINGS

FIG. 1 is a perspective view, showing a prior art window.

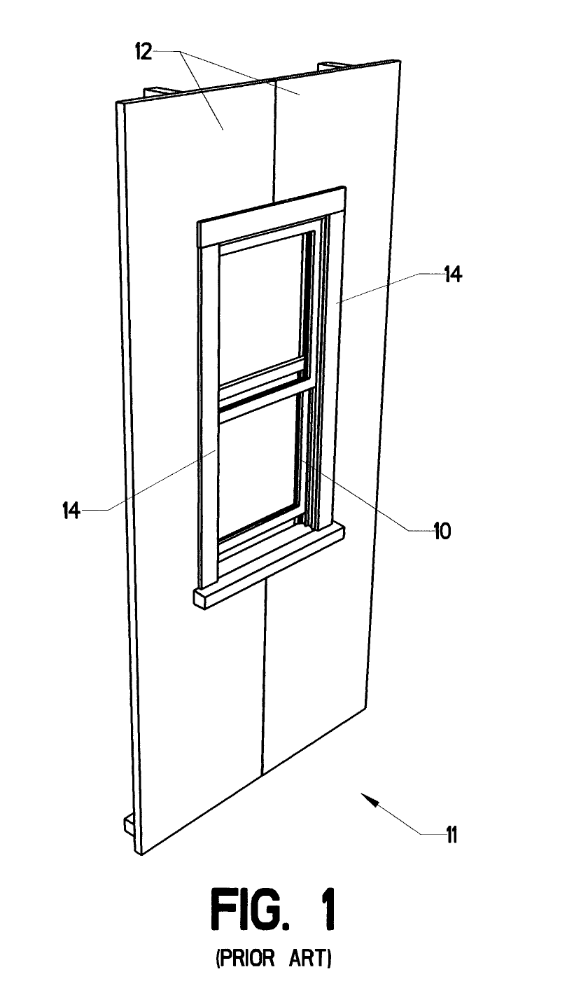

FIG. 2 is a perspective view, showing a prior art window.

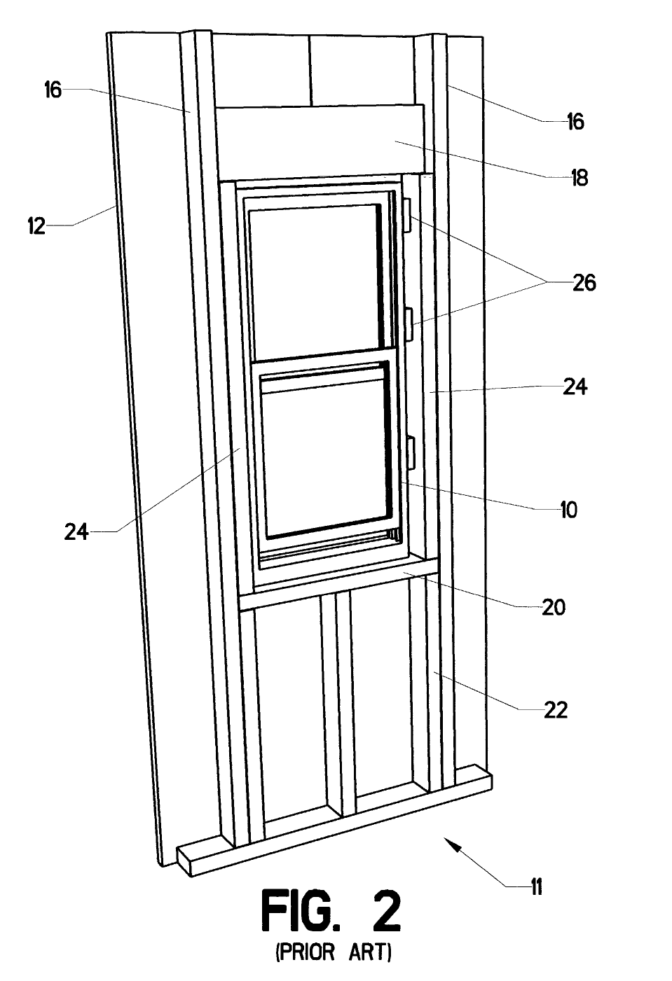

FIG. 3 is a perspective view, showing a prior art window.

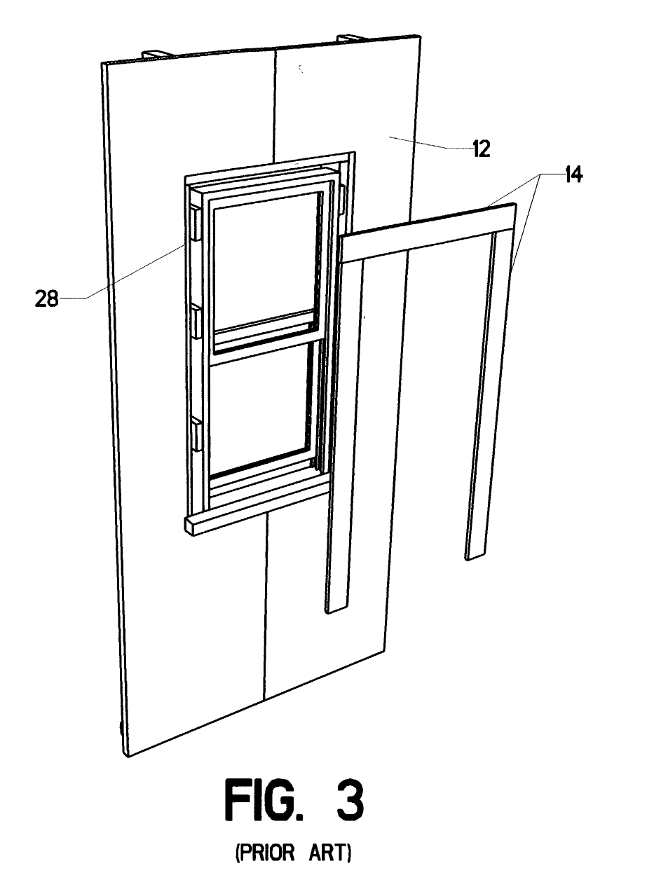

FIG. 4 is a perspective view, showing a prior art window being removed.

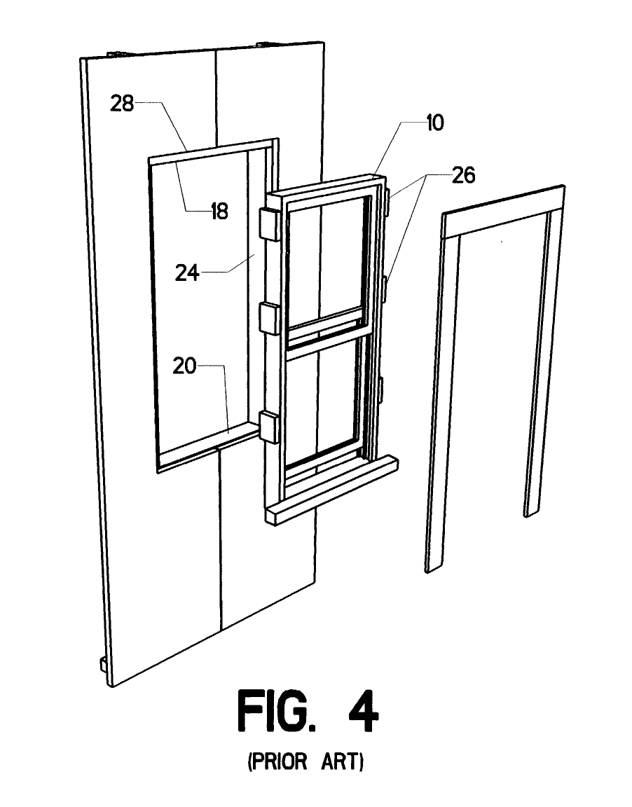

FIG. 5 is a perspective view, showing a modern window being installed.

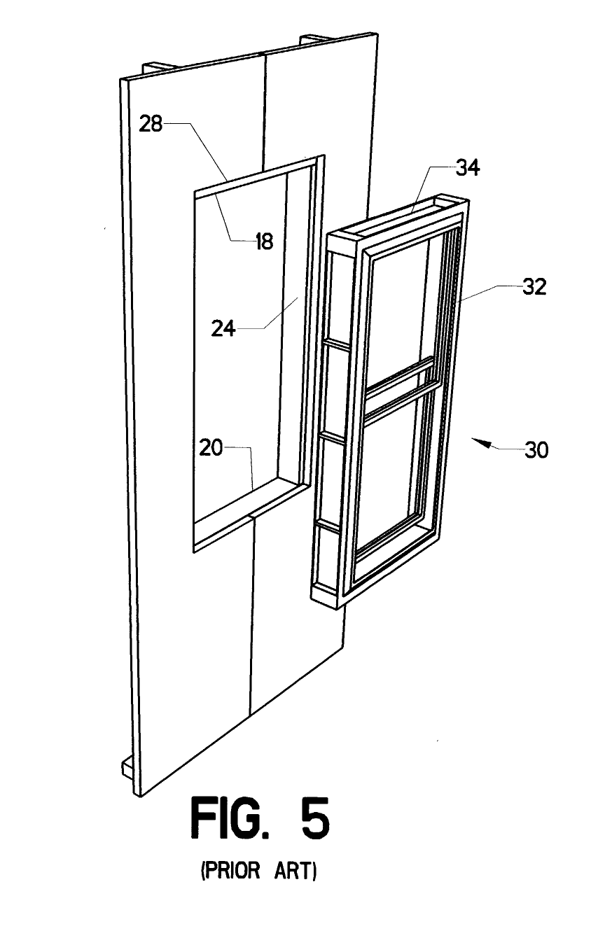

FIG. 6 is a perspective view, showing a modern window installed.

FIG. 7 is a perspective view, showing the present invention.

FIG. 8 is a perspective view, showing the present invention.

FIG. 9 is an isometric view, showing the present invention

FIG. 10 is a perspective view, showing the present invention.

FIG. 11 is a perspective view, showing the present invention.

FIG. 12 is a perspective view, showing the present invention.

### REFERENCE NUMERALS IN THE DRAWINGS

| | | | |
|---|---|---|---|
| 10 | old window | 11 | wall |
| 12 | siding | 14 | casing |
| 16 | stud | 18 | header |
| 20 | portal base | 22 | cripple stud |
| 24 | portal side | 26 | shim |
| 28 | opening | 30 | new window |
| 32 | window facing | 34 | box structure |
| 38 | gap | 40 | trim strip |
| 42 | miter cut | 44 | facing |
| 46 | contact adhesive | 48 | backing |
| 50 | trim strip roll | 52 | dispenser box |
| 54 | feed slot | 58 | handle |
| 62 | outer portion | 64 | inner portion |

### DETAILED DESCRIPTION OF THE INVENTION

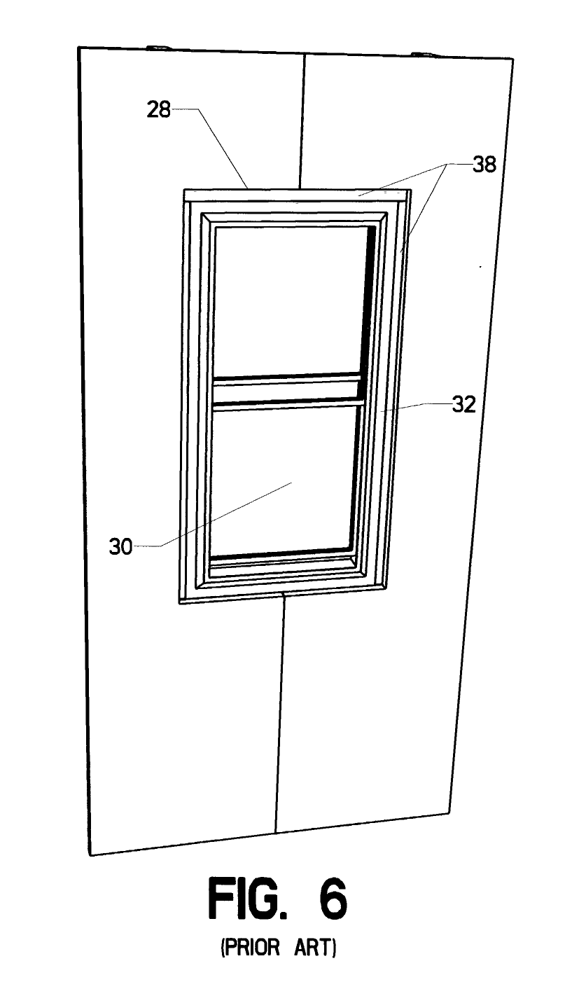

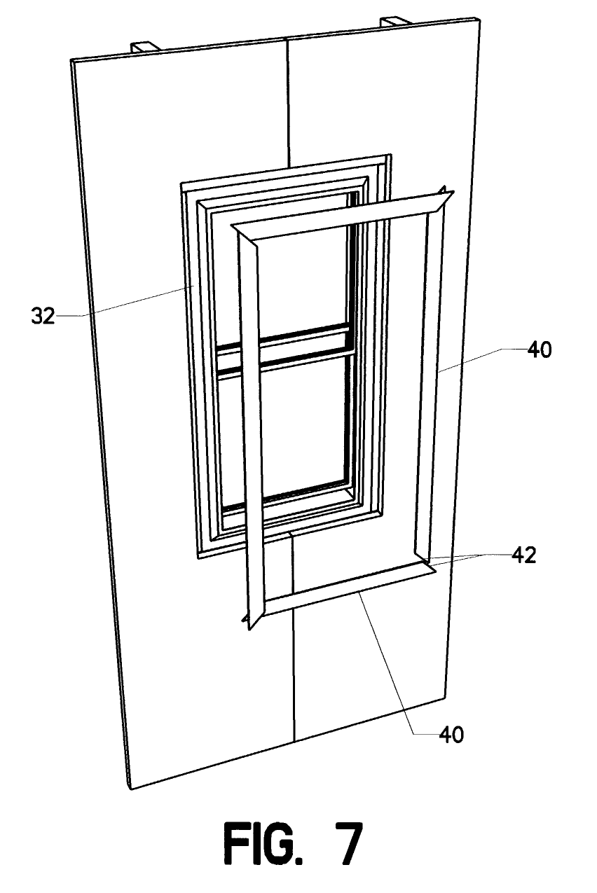

As explained previously, FIG. 6 shows new window 30 installed in opening 28, leaving gaps 38. In FIG. 7, four trim strips 40 have been cut to fit over window facing 32 and cover gaps 38. Each trim strip 40 has a pair of miter cuts 42. Other types of joinery can be used between adjoining trim strips, such as square cuts. The back surface of each trim strip 40 (facing away from the viewer as shown) is covered with a high-strength adhesive strip. These strips are pressed into contact with facing 32, thereby holding each trim strip 40 in place.

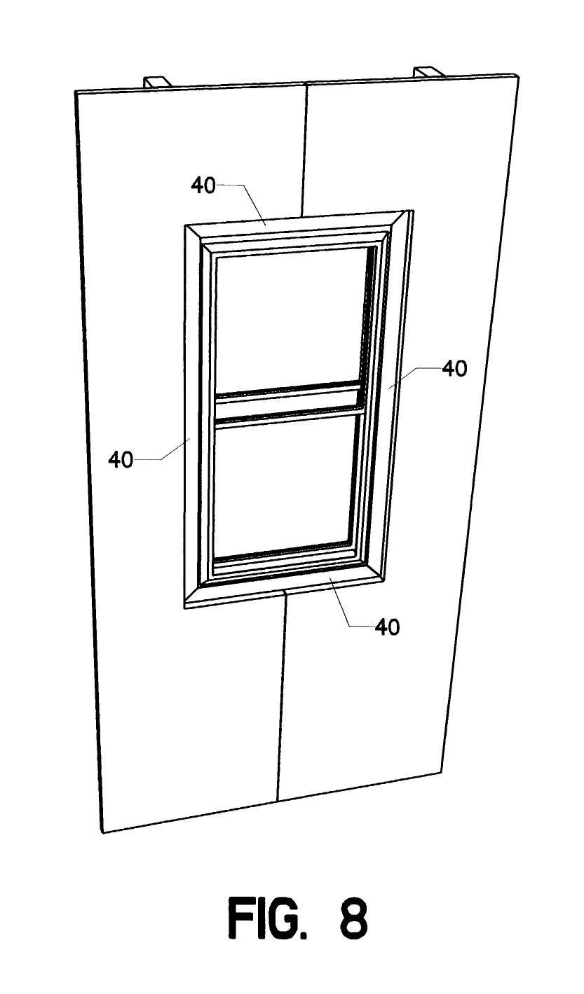

FIG. 8 shows the four trim strips 40 pressed into place, with the four pairs of miter cuts 42 aligned, a bead of caulk can be applied around the outer perimeter of the four trim strips 40 to provide additional trim strip bonding and a weather tight seal. The installation shown will last for many years.

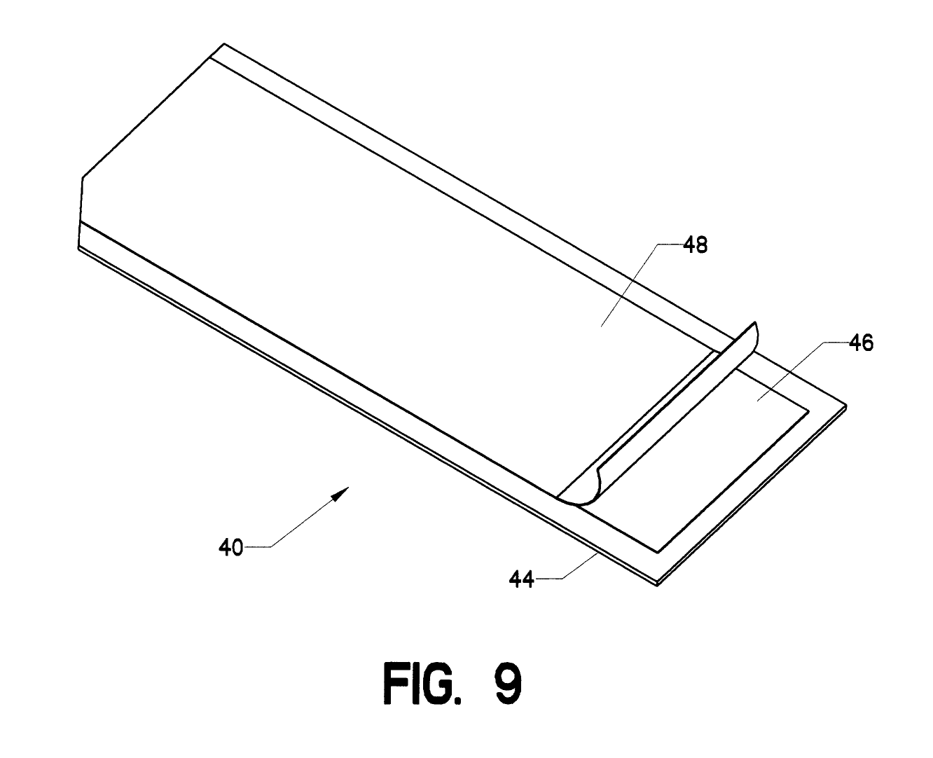

The material used for the trim strips 40 must be easily cut to the appropriate shape, since it is impractical to have trim strips 40 pre-cut to the right length and shape (owing to the endless variety of such lengths and shapes which will be needed for various installations). FIG. 9 shows a section of trim strip 40 in more detail. The primary structural element is facing 44. It has two sides. The side facing away from the viewer is the side facing the viewer in FIGS. 7 and 8. It is a finished surface having a smooth, aesthetically appealing appearance. It matches or visually blends with the window material. It can also be painted to match the color of other trim. The side facing toward the viewer in FIG. 9 has a strip of contact adhesive 46 affixed. Contact adhesive 46 is covered by a peelable backing 48.

Facing 44 is preferably made from an inexpensive plastic material such as polyvinyl chloride (PVC). Those skilled in the art will know that many grades and formulations of PVC are available. For this application, a grade should be selected which is capable of some deformation while retaining the elastic memory to retain its original flat shape. The need for these features will be made apparent in the following.

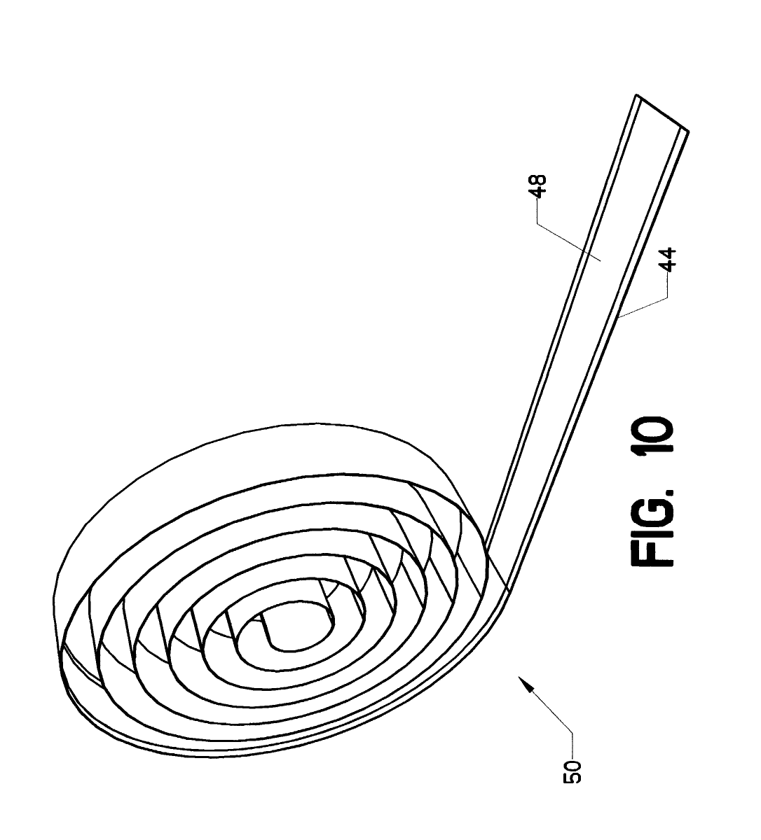

A user installing windows will need many feet of trim strips 40. It is difficult to carry such strips. Additionally, if such strips are cut into fixed lengths, many feet of scrap will result. Accordingly, it is preferable to carry such strips in the form of a roll. FIG. 10 shows trim strip roll 50. It is simply a roll of facing 44 with the adhesive and backing 48 in place. The PVC is selected so that it is capable of deforming to form the roll without retaining the deformation. In other words, when drawn out of the roll, it will return nearly to a flat state (some warpage may remain, but this will be easily smoothed during installation). Because of this fact, trim strip roll 50 has a tendency to unwind itself. It is therefore desirable to retain trim strip roll 50 in some sort of housing.

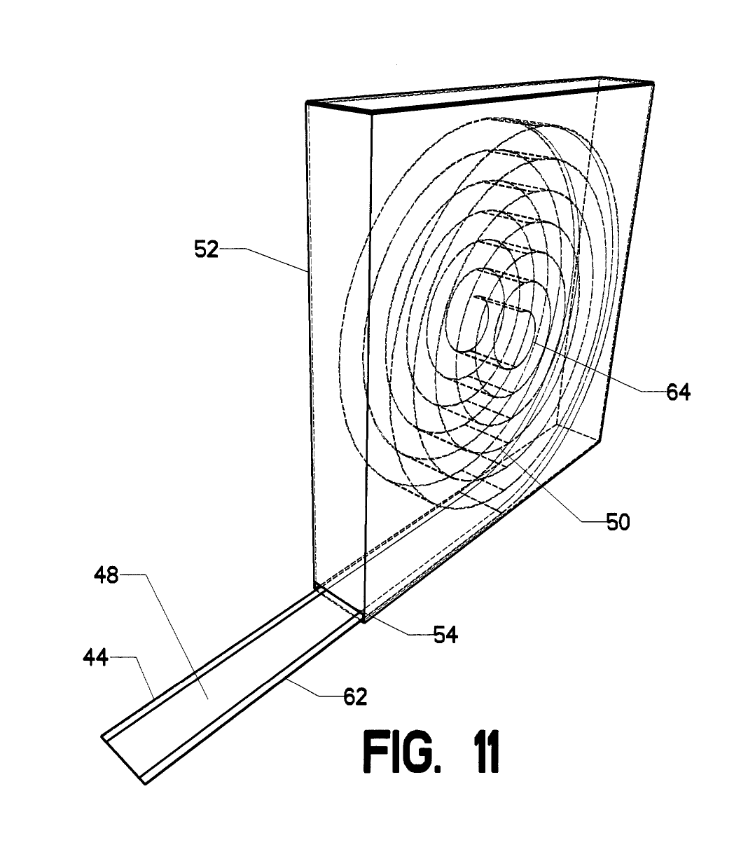

FIG. 11 shows trim strip roll 50 placed inside dispenser box 52. Dispenser box 52 is preferably made of an inexpensive material such as cardboard. The inner portion 64 of trim strip roll 50 is placed near the box's center. Outer portion 62 (coming off the outside of the roll) extends out of dispenser box 52 through feed slot 54.

When the user needs a piece of trim strip 40, he or she grabs outer portion 62 and pulls a sufficient length out of dispenser box 52. The user then cuts this portion free using a utility knife or other suitable implement. The free portion is then flattened and cut to fit the desired trim application. It can be cut using a utility knife, tin snips, or other prior art equipment. Those skilled in the art will realize that the loops of trim strip 40 contained within trim strip roll 50 can be bunched much more tightly than is illustrated. Thus, many feet of the material can be contained within a box of modest size.

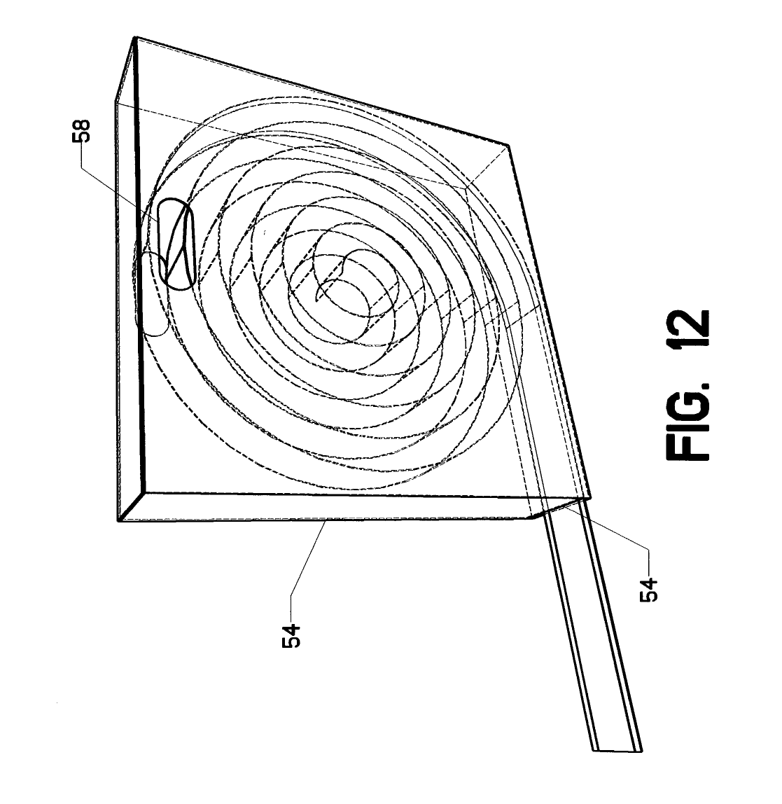

Additional features can be added to dispenser box 52 to improve the device. FIG. 12 depicts improved dispenser box 54. Those skilled in the art will also realize that a full box—containing many feet of trim strip 40—can be quite heavy. Handle 58—which is simply a slot punched through the sides of the box—can added to dispenser box 54 to aid in carrying the device to the work site.

It is often necessary to reduce the width of facing 44. It is not generally practical to reduce the width using a cutting action, since this type of “rip” cut would have to be very long and straight (although it could be done on a table saw, such devices are not generally carried to the worksite). The PVC material used for trim strip 40 can be placed in a mechanical press break or shear, as is typically used for sheet metal work. The shear will simply shear the trim strip to the appropriate width. The press break, will bend the trim strip—thereby scoring it along a straight line which can then be manually cut.

Many additional operations can be performed on trim strips 40. They can be ripped (such as by a table saw) to reduce their overall width, sheared to reduce length, miter cut for joinery, roll formed for larger curves, sanded, and painted.

Although the installation has been shown on a structure using simple panel siding, the invention can be employed with virtually any type of construction, including formed concrete, concrete block, lapped siding, and brick veneer siding. It is equally applicable to finishing door installations, cabinetry, and interior trim. The principles of using the invention for these applications is the same as for the window application illustrated.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the following claims, rather than by the examples given.

Having described my invention, I claim:

1. a trim strip which can be installed by a user, comprising:
a. a facing, having a first side and a second side;
b. a band of contact adhesive, affixed to said second side of said facing;
c. a backing, removably covering said band of contact adhesive on said second side of said facing;
d. wherein said first side of said facing is a smooth and aesthetically pleasing surface; and
e. wherein said facing is made of a flexible material having a tendency to resume its original shape after a limited amount of bending.

2. a trim strip as recited in claim 1, wherein said facing, said band of contact adhesive, and said backing are coiled into a trim strip roll.

3. a trim strip as recited in claim 2, wherein:
a. said trim strip roll has an inner portion proximate the center of said trim strip roll and an outer portion distal from said center of said trim strip roll;
b. said trim strip roll is contained within a dispenser box; and
c. said dispenser box opens into a feed slot, through which said outer portion of said trim strip roll can be passed so that said user can grasp said outer portion and progressively pull said trim strip out of said dispenser box.

4. a trim strip as recited in claim 3, wherein said dispenser box further comprises a handle.

5. a trim strip as recited in claim 1, wherein said facing is made of PVC.

6. a trim strip as recited in claim 2, wherein said facing is made of PVC.

7. a trim strip as recited in claim 3, wherein said facing is made of PVC.

8. a trim strip as recited in claim 4, wherein said facing is made of PVC.
